(19) United States
(12) Patent Application Publication
(10) Pub. No.: US 2003/0224739 A1
(43) Pub. Date: Dec. 4, 2003

(54) Electronic apparatus including two foldable bodies

(75) Inventor: Masaaki Ikuta, Ome-Shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/445,184

(22) Filed: May 27, 2003

(30) Foreign Application Priority Data
May 31, 2002 (JP) 2002-159515

(51) Int. Cl. H04M 1/00

(52) U.S. Cl. 455/90.3; 455/550.1

(57) ABSTRACT

There is disclosed an electronic apparatus comprising a first body including a plurality of operation keys, a second body including a display screen, and a hinge portion disposed to connect the first body to the second body so that the bodies can be pivoted. The first and second bodies can be displaced between a first form in which the bodies are folded so as to dispose the operation keys opposite to the display screen and a second form in which the bodies are opened so as to expose the operation keys and display screen. An other operation key is disposed on the second body. This other operation key is positioned between the display screen and hinge portion.

### CROSS-REFERENCE TO RELATED APPLICATIONS

This application is based upon and claims the benefit of priority from the prior Japanese Patent Application No. 2002-159515, filed May 31, 2002, the entire contents of which are incorporated herein by reference.

### BACKGROUND OF THE INVENTION

1. Field of the Invention

The present invention relates to folding electronic apparatuses such as cellular phones, particularly to a structure for improving operability of electronic apparatuses.

2. Description of the Related Art

For example, a cellular phone includes a body including keys and a display screen. For this body, miniaturization and weight reduction have been promoted to enhance portability. In this case, when the body is excessively miniaturized, there is a possibility that operability in inputting phone numbers or characters is impaired. Therefore, in recent years, a so-called folding cellular phone has been dominant in which the body is folded during transport and opened to expose the display screen during use.

In “Jpn. Pat. Appln. KOKAI Publication No. 2001-298514, a related-art conventional folding cellular phone is disclosed. The cellular phone is constituted of first and second bodies and a hinge portion. The first body includes a plurality of operation keys such as dial keys for inputting phone numbers and characters. The second body includes a display screen on which input information is displayed. The hinge portion connects the first body to the second body so that the bodies can be pivoted. Therefore, the first and second bodies can be displaced between a first form in which bodies are folded so as to dispose the operation keys opposite to the display screen and a second form in which the bodies are opened so as to expose the operation keys and display screen.

In recent years, many functions have become available on cellular phones. For example, it is possible to access information sites of movies, music, and games via a communication network. The increase in functions on a cellular phone results in an increase in the number of operation keys arranged on the first body. Therefore, the arrangement of the operation keys inevitably becomes complicated.

As a countermeasure, in the above-described cellular phone, a scroll key is disposed in the hinge portion which connects the first body to the second body. The scroll key is operated with the fingertip to move a cursor on the display screen and scroll the display of the functions. This reduces the number of operation keys arranged on the first body, and prevents the arrangement of the operation keys from becoming complicated.

According to the cellular phone, the hinge portion includes an outer peripheral surface which is curved in a circular arc shape. This outer peripheral surface of the hinge portion extends upwards from a boundary portion between the first and second bodies, when the first and second bodies are displaced into the second form. The scroll key is disposed on the outer peripheral surface of the hinge portion.

Additionally, the shape of the hinge portion is much smaller than the shapes of the first and second bodies. Therefore, the types of keys which can be arranged on the hinge portion are restricted, the shape and number of the keys are limited, and the operability of the keys is prevented from being enhanced.

### BRIEF SUMMARY OF THE INVENTION

According to an embodiment of the present invention, there is provided an electronic apparatus comprising: a first body including a plurality of operation keys; a second body including a display screen; and a hinge portion disposed between the first and second bodies. The hinge portion connects the first body to the second body so that the bodies can be pivoted. The first and second bodies can be displaced between a first form in which the bodies are folded so as to dispose the operation keys opposite to the display screen and a second form in which the bodies are opened so as to expose the operation keys and display screen. An other operation key is disposed on the second body. The other operation key is positioned between the display screen and hinge portion.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a cellular phone according to a first embodiment of the present invention;

FIG. 2 is a plan view of the cellular phone showing that first and second bodies are displaced into a second form in the first embodiment of the present invention;

FIG. 3 is a side view of the cellular phone showing that the first and second bodies are displaced into the second form in the first embodiment of the present invention;

FIG. 4 is a side view of the cellular phone showing that the first and second bodies are displaced into a first form in the first embodiment of the present invention;

FIG. 5 is a perspective view of the cellular phone according to a second embodiment of the present invention;

FIG. 6 is a plan view of the cellular phone showing that the first and second bodies are displaced into the second form in the second embodiment of the present invention;

FIG. 7 is a side view of the cellular phone showing that the first and second bodies are displaced into the second form in the second embodiment of the present invention;

FIG. 8 is a side view of the cellular phone showing that the first and second bodies are displaced into the first form in the second embodiment of the present invention;

FIG. 9 is a plan view of the cellular phone showing that the first and second bodies are displaced into the second form in a third embodiment of the present invention;

FIG. 10 is a side view of the cellular phone showing that the first and second bodies are displaced into the second form in the third embodiment of the present invention; and

FIG. 11 is a side view of the cellular phone showing that the first and second bodies are displaced into the first form in the third embodiment of the present invention.

### DETAILED DESCRIPTION OF THE INVENTION

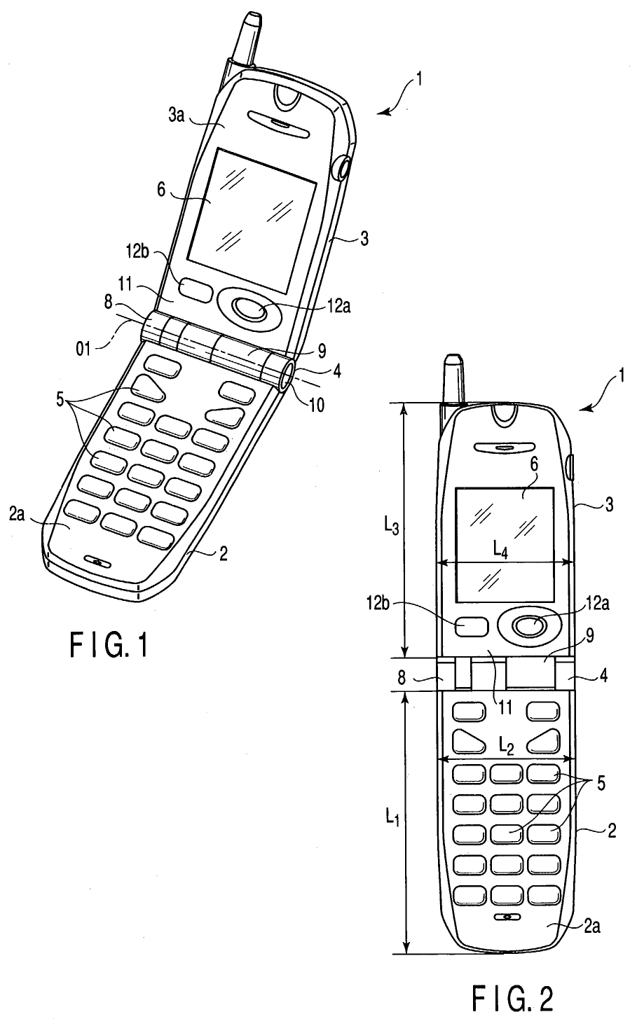

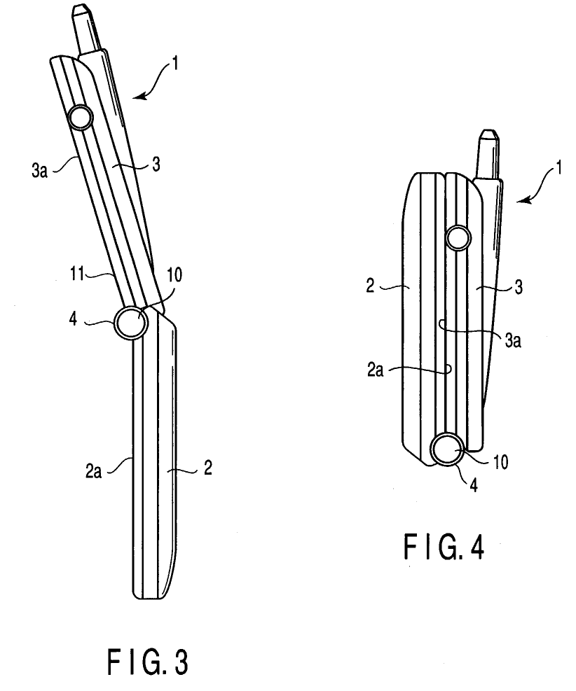

A first embodiment of the present invention will be described hereinafter with reference to FIGS. 1 to 4.

FIGS. 1 to 4 show a folding cellular phone 1 as an electronic apparatus. The cellular phone 1 includes a first body 2, second body 3, and hinge portion 4. The first body 2 constitutes the main body of the cellular phone 1. The first body 2 has a flat square box shape, and a length L1 greater than its width L2. The first body 2 includes a flat first surface 2a, and a plurality of push-type operation keys 5 are disposed on the first surface 2a. Examples of the operation keys 5 include a dial key for use in inputting phone numbers and characters, a power key for turning ON/OFF the cellular phone 1, a transmitter/receiver key for use in making or answering a phone call, and the like.

The second body 3 constitutes a display unit of the cellular phone 1. The second body 3 has a flat square box shape, and a length L3 greater than its width L4. The second body 3 includes a flat second surface 3a, and a square display screen 6 is disposed in the middle of the second surface 3a. The display screen 6 displays, for example, the phone numbers, characters, images, and contents of set functions. The length L3 and width L4 of the second body 3 are substantially equal to the length L1 and width L2 of the first body 2.

The hinge portion 4 connects the first body 2 to the second body 3 so that the bodies can be pivoted. The hinge portion 4 includes a first support portion 8, second support portion 9, and hinge shaft 10. The first support portion 8 is formed in one end of the first body 2. The first support portion 8 extends upwards from the first surface 2a of the first body 2, and includes an outer peripheral surface which is bent in a circular arc shape. The second support portion 9 is formed in one end of the second body 3. The second support portion 9 extends towards the first support portion 8 of the first body 2 from one end of the second body 3, and includes an outer peripheral surface which is bent in the circular arc shape. The first and second support portions 8 and 9 are arranged in one row in the width direction of the first and second bodies 2 and 3. The hinge shaft 10 extends in the width direction of the first and second bodies 2 and 3, and extends through the first and second support portions 8 and 9.

Therefore, the cellular phone 1 can be displaced between first and second forms centering on an axis O1 of the hinge shaft 10. In the first form, the first and second bodies 2 and 3 are folded so that the operation keys 5 are disposed opposite to the display screen 6. In the second form, the first and second bodies 2 and 3 are opened in one row so that the operation keys 5 and display screen 6 are exposed. As shown in FIGS. 1 to 3, when the first and second bodies 2 and 3 are opened in the second form, the hinge portion 4 is positioned between the first and second bodies 2 and 3, and the first surface 2a of the first body 2 is positioned on substantially the same plane as that of the second surface 3a of the second body 3.

As shown in FIG. 1, the second surface 3a of the second body 3 includes a region 11 disposed between the display screen 6 and hinge portion 4. Two operation keys 12a and 12b other than the operation keys 5 are disposed in the region 11. The operation keys 12a and 12b are of the push type, depressed with fingertips, and arranged in one row in the width direction of the second body 3 in a position disposed adjacent to the display screen 6.

One operation key 12a is used, for example, to move a cursor on the display screen 6 and to select the content of the function. The other operation key 12b is used, for example, to manipulate the content of the function displayed on the display screen 6. In other words, the operation keys 12a and 12b are used mainly to browse information using the Internet or to exchange character information (electronic mail) on the Internet. Therefore, during the use of the cellular phone 1 using the Internet, the frequencies of use of the operation keys 12a and 12b are higher than those of the operation keys 5 of the first body 2.

According to the first embodiment of the present invention, since the second surface 3a of the second body 3 only includes the display screen 6, it is possible to sufficiently secure a flat and large region 11 between the display screen 6 and hinge portion 4 in the second surface 3a. Therefore, the operation keys 12a and 12b which are operated in using the Internet can be disposed in the region 11 of the second surface 3a. Therefore, the number and type of the operation keys 12a and 12b are not restricted, and layout of the operation keys 12a and 12b is easily obtained.

Furthermore, according to the above-described constitution, when the cellular phone 1 is displaced into the second form, the operation keys 12a and 12b deviate toward the display screen 6 rather than toward the hinge portion 4. Therefore, when an operator operates the operation keys 12a and 12b with fingertips, the operator holds a middle portion of the cellular phone 1 displaced in the second form along the length direction, and the operator's hand extends over both the first and second bodies 2 and 3.

As a result, the cellular phone 1 can be firmly supported with one hand, and the posture of the cellular phone 1 is stabilized. Therefore, the operability of the operation keys 12a and 12b becomes satisfactory, and it is possible to obtain the cellular phone 1 which is easy to use.

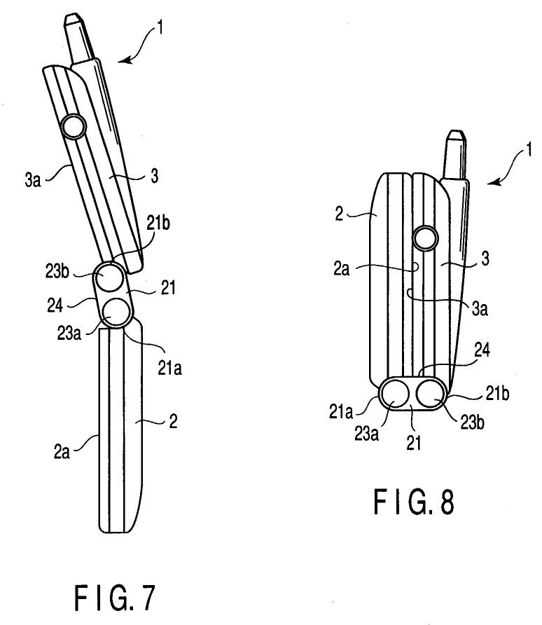

It is to be noted that the present invention is not limited to the first embodiment. FIGS. 5 to 8 show a second embodiment of the present invention.

The cellular phone 1 of the second embodiment is different from that of the first embodiment in a constitution of a portion for connecting the first body 2 to the second body 3. The other basic constitution of the cellular phone 1 is similar to that of the first embodiment. Therefore, in the second embodiment, the same constituting portions as those of the first embodiment are denoted with the same reference numerals, and the description thereof is omitted.

As shown in FIGS. 5 to 8, the cellular phone 1 includes a third body 21. The third body 21 is disposed between the first body 2 and second body 3. The third body 21 includes a first end 21a and second end 21b. The second end 21b is positioned on the opposite side of the first end 21a. The first end 21a of the third body 21 is pivotably connected to one end of the first body 2 via a first hinge shaft 23a. The second end 21b of the third body 21 is pivotably connected to one end of the second body 3 via a second hinge shaft 23b. The first and second hinge shafts 23a and 23b are disposed in parallel with each other along the width direction of the first to third bodies 2, 3 and 21. Therefore, the third body 21 extends between the first body 2 and second body 3 and connects the first body to the second body so that the bodies can be pivoted.

By this connection, the cellular phone 1 can be displaced between the first and second forms centering on an axis O2 of the first and second hinge shafts 23a and 23b. In the first form, the first and second bodies 2 and 3 are folded so that the operation keys 5 are disposed opposite to the display screen 6. In the second form, the first and second bodies 2 and 3 are opened in one row so that the operation keys 5 and display screen 6 are exposed.

The third body 21 has a flat box shape, and has a length L5 and width L6. The length L5 of the third body 21 is smaller than the thickness of the cellular phone 1 at the time when the first and second bodies 2 and 3 are displaced in the first form. The width L6 of the third body 21 is equal to the widths L2 and L4 of the first and second bodies 2 and 3. Therefore, the width L6 of the third body 21 is greater than the length L5.

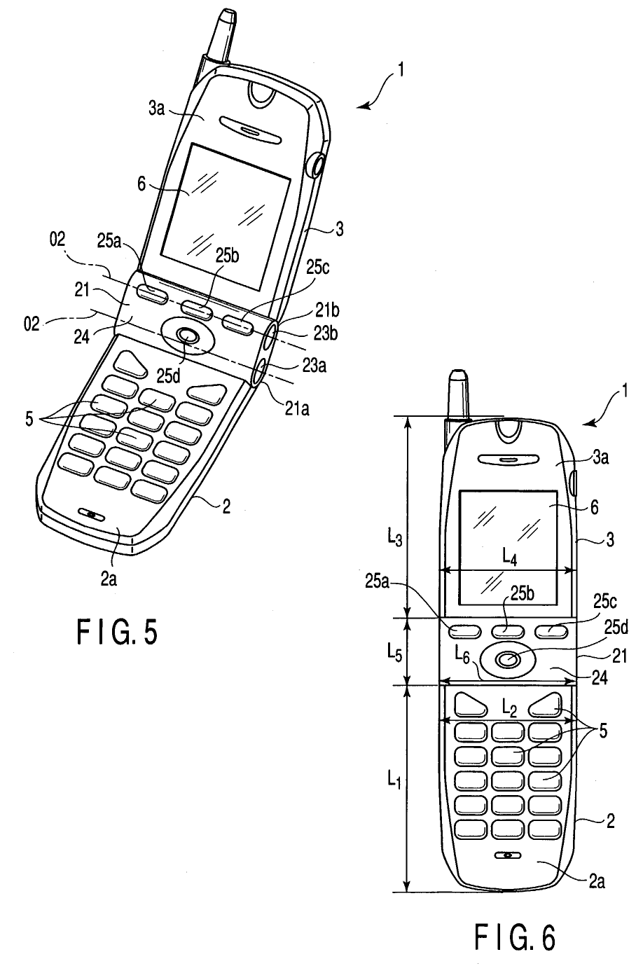

As shown in FIGS. 5 and 6, when the cellular phone 1 is displaced in the second form, the third body 21 is positioned between the first and second bodies 2 and 3. This third body 21 has a flat third surface 24. When the cellular phone 1 is displaced in the second form, the third surface 24 is connected to the first surface 2a of the first body 2 and the second surface 3a of the second body 3, and is positioned right under the display screen 6.

First to fourth other operation keys 25a to 25d of push type are disposed on the third surface 24. The first to fourth operation keys 25a to 25d are used to manipulate the content of the functions displayed on the display screen 6. The first to third operation keys 25a to 25c are arranged in one row in the width direction of the third body 21 in a position disposed adjacent to a lower edge of the display screen 6. The fourth operation key 25d is used to move the cursor on the display screen 6 and to select the content of the function, and is positioned in a middle portion of the third surface 24. Therefore, the first to fourth operation keys 25a to 25d are used mainly to browse information using the Internet or exchange electronic mail. In the use of the cellular phone 1 using the Internet, the first to fourth operation keys 25a to 25d have higher frequencies of use than those of the operation keys 5 of the first body 2.

As shown in FIG. 8, when the cellular phone 1 is displaced in the first form, the third body 21 is held in a posture along the thickness direction of the cellular phone 1. Therefore, the third surface 24 of the third body 21 is covered with the first and second bodies 2 and 3.

According to the constitution, the first body 2 is pivotably connected to the second body 3 via the separate third body 21. When the cellular phone 1 is displaced in the second form, the third body 21 has the flat third surface 24 continued to the first and second surfaces 2a and 3a. Therefore, it is possible to secure a sufficient area of the third surface 24. The first to fourth operation keys 25a to 25d operated mainly in using the Internet can be disposed on the third surface 24.

Therefore, the number and type of the first to fourth operation keys 25a to 25d are not easily restricted, and the degree of freedom in the layout of the operation keys 25a to 25d increases.

Furthermore, the third body 21 is positioned between the first and second bodies 2 and 3, when the cellular phone 1 is used. Therefore, when the first to fourth operation keys 25a to 25d are operated with fingertips, the operator manually holds the middle portion of the cellular phone 1 displaced in the second form along the length direction, and the operator's hand extends to both the first body 2 and third body 21. Therefore, the cellular phone 1 can be firmly supported with one hand, and the operability of the first to fourth operation keys 25a to 25d becomes satisfactory.

Additionally, according to the above-described constitution, a broad range of the second surface 3a of the second body 3 can be used as an installation region of the display screen 6. Therefore, the size of the display screen 6 is not limited by the first to fourth operation keys 25a to 25d, and the display screen 6 can be enlarged.

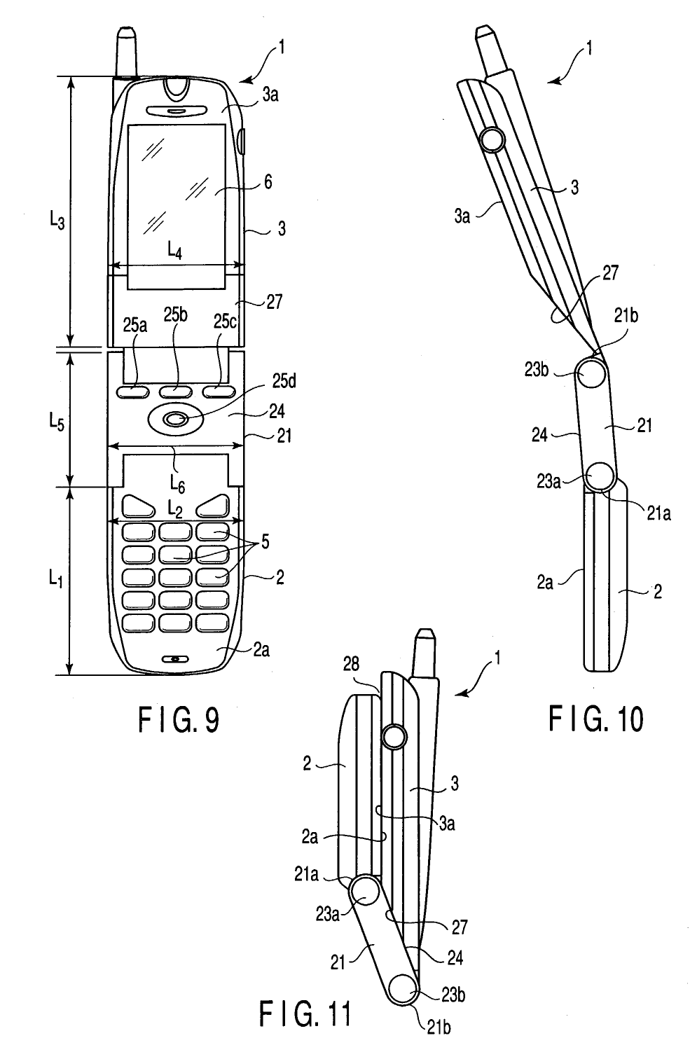

FIGS. 9 to 11 show a third embodiment of the present invention.

The third embodiment is a development of the second embodiment. As shown in FIG. 9, the length L3 of the second body 3 is greater than the length L1 of the first body 2. The length L5 of the third body 21 is smaller than the length L1 or L3 of the first or second body 2 or 3, but is greater than that of the third body 21 of the second embodiment.

FIG. 11 shows that the cellular phone 1 is displaced in the first form. In the first form, the third body 21 is held in an inclined posture with respect to the first and second bodies 2 and 3, and the third surface 24 of the third body 21 is disposed opposite to a part of the second surface 3a of the second body 3. Therefore, as long as the cellular phone 1 is displaced in the first form, the second surface 3a of the second body 3 is covered with the first body 2 and third body 21.

Furthermore, in the above-described constitution, when the cellular phone 1 is displaced in the first form, the third surface 24 of the third body 21 is disposed opposite to a part of the second surface 3a of the second body 3. Therefore, the portion of the second surface 3a disposed opposite to the third surface 24 includes a slant surface 27. The slant surface 27 tilts in a direction in which the thickness of the second body 3 is reduced toward the direction of the third body 21. Because of the presence of the slant surface 27, these first to third bodies 2, 3 and 21 can be folded so that the third body 21 and first body 2 overlap with the second body 3.

As shown in FIG. 9, one end of the display screen 6 extends to reach the slant surface 27, so that the display screen 6 is enlarged. Additionally, when the cellular phone 1 is displaced in the first form, tip ends of the first and second bodies 2 and 3 on the side opposite to the third body 21 deviate in the length direction of the bodies 2 and 3, and a step 28 is formed between the tip ends as shown in FIG. 11.

Therefore, in the present embodiment, the tip end of the second surface 3a of the second body 3 is exposed without being covered with the first body 2, and can be caught by the fingertips. Therefore, to displace the cellular phone 1 to the second form from the first form, a fingertip is first inserted in the step 28 to catch the second surface 3a. Thereby, the second body 3 can be pivoted in a direction apart from the first body 2, and the cellular phone 1 can easily be opened.

According to the third embodiment, since the length L3 of the first body 2 is greater than the length L1 or L5 of the first or third body 2 or 21, the area of the second surface 3a increases. Therefore, the display screen 6 can further be enlarged, and the display screen 6 can easily be seen.

Furthermore, when the cellular phone 1 is displaced in the second form, the third body 21 is positioned between the first body 2 and second body 3, and therefore the operator manually holds the middle portion of the cellular phone 1 displaced in the second form along the length direction. Therefore, the operator can firmly support the cellular phone 1 with one hand in operating the first to fourth operation keys 25a to 25d, and the posture of the cellular phone 1 is stabilized.

In the above-described embodiments, the operation keys disposed in the positions other than the first body are of the push type, but the present invention is not limited to this. For example, rotary operation keys such as a dial, an input device of a touch or stick type, or acu-points may also be used.

Furthermore, the electronic apparatus according to the present invention is not limited to the cellular phone. For example, the present invention can also be applied to information apparatuses such as an electronic notebook or personal digital assistants (PDA).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An electronic apparatus comprising:
a first body including a plurality of operation keys;
a second body including a display screen;
a hinge portion disposed between the first body and second body to connect the first body to the second body so that the bodies can be pivoted, the first and second bodies being displaceable between a first form in which the bodies are folded so as to dispose the operation keys opposite to the display screen and a second form in which the bodies are opened so as to expose the operation keys and display screen; and
an other operation key disposed on the second body and positioned between the display screen and hinge portion.

2. An electronic apparatus according to claim 1, wherein the other operation key of the second body has a frequency of use higher than that of the operation keys of the first body.

3. An electronic apparatus according to claim 1, wherein the other operation key is operated with a fingertip at the time of browsing an internet for information.

4. An electronic apparatus according to claim 1, wherein the other operation key is disposed beside the display screen.

5. An electronic apparatus according to claim 4, wherein the other operation key is operated with a fingertip in manipulating contents displayed on the display screen.

6. An electronic apparatus according to claim 4, wherein the other operation key is operated with a fingertip in selecting contents displayed on the display screen.

7. An electronic apparatus according to claim 1, wherein the first body comprises a first surface on which the operation keys are arranged, the second body comprises a second surface on which the display screen and the other operation key are disposed, and another operation key is disposed on the second surface, the other operation keys on the second surface being arranged in the width direction of the second body.

8. An electronic apparatus comprising:
a first body including a plurality of operation keys;
a second body including a display screen; and
a third body which is disposed between the first body and second body and which comprises a first end pivotably connected to one end of the first body and a second end pivotably connected to one end of the second body, the first and second bodies being displaceable between a first form in which the bodies are folded so as to dispose the operation keys opposite to the display screen and a second form in which the bodies are opened so as to expose the operation keys and display screen, the third body comprising at least one other operation key exposed when the first and second bodies are displaced into the second form.

9. An electronic apparatus according to claim 8, wherein the other operation key of the third body has a frequency of use higher than that of the operation keys of the first body.

10. An electronic apparatus according to claim 8, wherein the other operation key is operated with a fingertip at the time of browsing the Internet for information.

11. An electronic apparatus according to claim 8, wherein the other operation key is operated with a fingertip in manipulating or selecting content displayed on the display screen.

12. An electronic apparatus according to claim 8, wherein the first body comprises a first surface on which the operation keys are arranged, the second body comprises a second surface on which the display screen is disposed, the third body comprises a third surface on which the other operation key is disposed, and the third surface of the third body continues to the first and second surfaces when the first and second bodies are displaced into the second form.

13. An electronic apparatus according to claim 12, wherein still another operation key is disposed on the third surface of the third body, and the other operation keys on the third surface are arranged in the width direction of the third body.

14. An electronic apparatus according to claim 12, wherein the display screen and third surface are disposed adjacent to each other and exposed to the outside when the first and second bodies are displaced in the second form, and the other operation key is operated with a fingertip in manipulating or selecting content displayed on the display screen.

15. An electronic apparatus according to claim 12, wherein the first and second bodies are pivotably connected to the third body via hinge shafts, the first to third bodies have a length which extends in a direction crossing at right angles the axes of the hinge shafts, the second body has a length greater than that of the first body, and the third body has a length smaller than that of the first and second bodies.

16. An electronic apparatus according to claim 15, wherein the second body comprises a slant surface to avoid the third body when the first and second bodies are displaced into the first form.

17. An electronic apparatus according to claim 16, wherein the third surface of the third body is positioned between the first surface and slant surface when the first and second bodies are displaced into the second form.

18. A cellular phone comprising:
a main body including a plurality of operation keys;
a display unit including a display screen; and
a hinge portion disposed between the main body and display unit to connect the main body to the display unit so that the main body and display unit can be pivoted, the main body and display unit being displaceable between a first form in which the main body and display unit are folded so as to dispose the operation keys opposite to the display screen and a second form in which the bodies are opened so as to expose the operation keys and display screen; and
at least one other operation key disposed on the display unit and positioned between the display screen and hinge portion.

19. A cellular phone according to claim 18, wherein the other operation key is operated with a fingertip in manipulating or selecting content displayed on the display screen.
